(19) United States
(12) Patent Application Publication
(10) Pub. No.: US 2011/0169768 A1
(43) Pub. Date: Jul. 14, 2011

(54) ELECTROSTATIC DETECTION DEVICE, INFORMATION APPARATUS, AND ELECTROSTATIC DETECTION METHOD

(76) Inventor: Kenichi Matsushima, Chiba (JP)

(21) Appl. No.: 12/737,354

(22) PCT Filed: Jun. 23, 2009
(86) PCT No.: PCT/JP2009/061376

§ 371 Date: Feb. 7, 2011

(30) Foreign Application Priority Data
Jul. 8, 2008 (JP) 2008-178098
Feb. 5, 2009 (JP) 2009-024975

(51) Int. Cl. G06F 3/045

(52) U.S. Cl. 345/174

(57) ABSTRACT

An electrostatic detection device includes a detection panel 1 having one or a plurality of detection electrodes, charge/discharge means 2 for repeatedly performing charge/discharge, characteristic extraction means 3 for repeatedly extracting characteristics, accumulation analog/digital conversion means 4 for accumulating the characteristics and performing analog/digital conversion, post-processing means 5 for calculating approach or a position of the object, control means 7 for managing an overall state and sequence, gain changing means 52 for changing a gain of the first and last characteristic extraction of the charge/discharge, and abnormality detection means 10 for detection whether or not there is abnormality. Accordingly, it is possible to attenuate or remove an influence of noises with a simple configuration.

### TECHNICAL FIELD

The present invention relates to an electrostatic coupling-type touch sensor detecting approach or a position of an object such as a human finger as changes in electrostatic coupling by one or a plurality of detection electrodes.

### BACKGROUND ART

It is known that the external electrostatic capacitance of an electrode or electrostatic capacitance between electrodes is changed when an object such as a human finger having stray capacitance approaches the electrode. Applying such a phenomenon, an electrostatic detection device detecting approach, a position, or the like of the object has been put into practical use.

In such an electrostatic detection device, as shown in FIG. 18, charge/discharge means 12 repeatedly performs charge, discharge, or charge/discharge, hereinafter, merely referred to as charge/discharge on electrodes of a detection panel 11 having detection electrodes, characteristics of charge/discharge changed by the approach of an object are repeatedly extracted by characteristic extraction means 13, the obtained characteristics are accumulated by accumulation means 14, and analog/digital conversion is performed by analog/digital means 16, and the approach or a position of the object is acquired from an output of the analog/digital conversion means 16 by post-processing means 15. Herein, control means 17 is provided to manage an overall state and sequence.

The reason for accumulating and detecting the repeated characteristics is because a change in electrostatic capacitance by the approach of the human or the like is gentle, and it attenuates the influence of noise.

A method of performing synthesis while performing reverse-phase charge/discharge within a short time to extract only a frequency component relating to charge/discharge is disclosed (e.g., see PLT 1).

When, as shown in FIG. 8(a), there is influence from noise, FIG. 8(b)shows a method of attenuating the influence of noise by temporally and alternately inverting and accumulating the influence of noise. In FIG. 8, a horizontal axis is a common time, and arrows indicate the influence of noise at the point in time of detection. A vertical axis of FIG. 8(a) is a size of the influence of noise, and a vertical axis of FIG. 8(b) is a value obtained by inverting and accumulating the influence of noise. Herein, a black circle mark indicates the accumulated influence of noise at the point in time for each inversion cycle.

A method of performing reverse-phase charge/discharge within a short time to perform synthesis in order to extract only the frequency of charge/discharge, or a method of accumulating a waveform synchronized with charge/discharge is disclosed (e.g., see PLTs 1 and 2).

In addition, a method of inputting a signal synchronized with driving of a liquid crystal display device and stopping electrostatic detection in a period of generating noise is disclosed (e.g., see PLT 3).

### RELATED ART DOCUMENT

### Citation List

Patent Document 1: Japanese Patent No. 4014660

Patent Document 2: US Unexamined Patent Application Publication No. 2007/0257890

Patent Document 3: Japanese Unexamined Patent Application Publication No. 2006-146895

### SUMMARY OF INVENTION

### Technical Problem

As described above, the influence of noise is attenuated by accumulating characteristics a plurality of times while performing synthesis of reverse-phase charge/discharge within a short time, however there is a problem in that the attenuation of noise is not necessarily sufficient when a great degree of noise is applied.

Thus, an object of an electrostatic detection device and a method thereof of the invention is to realize an electrostatic detection device, an information apparatus, and a method thereof to reduce the influence of noise by relatively simple means or method.

### Solution to Problem

An electrostatic detection device of the invention includes a detection panel having one detection electrode and the other detection electrode, charge/discharge means for repeatedly performing charge/discharge on the detection electrodes or an intersection thereof, characteristic extraction means for repeatedly extracting characteristics of charge/discharge changed by the approach of an object, accumulation means for accumulating the characteristics repeatedly extracted by the characteristic extraction means, analog/digital conversion means for performing analog/digital conversion, post-processing means for calculating the approach or position of the object from an output of the analog/digital conversion means, abnormality detection means, and control means for managing the overall state and sequence. Herein, the characteristic extraction means includes QV conversion means for converting the charge/discharge characteristics from the charge/discharge means into values, gain changing means for changing a gain of the characteristic extraction means, and inversion means for inverting an output of the gain changing means synchronizing with an operation of the charge/discharge means.

A first electrostatic detection method of the invention includes a charge/discharge process of repeatedly performing charge/discharge on detection electrodes of a detection panel, a characteristic extraction process of repeatedly extracting characteristics of charge/discharge changed by approach of an object, an accumulation process of accumulating the characteristics repeatedly extracted by the characteristic extraction process, an analog/digital conversion process of performing analog/digital conversion on the characteristics, a post-processing process of calculating approach or a position of the object from an output of the analog/digital conversion process, and a control process of managing an overall state and sequence. As necessary, the charge/discharge process, the characteristic extraction process, the accumulation process, and the analog/digital conversion process are repeated a predetermined number of times.

Herein, the characteristic extraction process includes a QV conversion process of converting the charge/discharge characteristics from the charge/discharge process into values, a gain changing process of changing a gain of the characteristic extraction process, and an inversion process of inverting an output of the gain changing process synchronizing with an operation of the charge/discharge process.

A second electrostatic detection method includes a charge/discharge process of repeatedly performing charge/discharge on detection electrodes of a detection panel, a characteristic extraction process of repeatedly extracting characteristics of charge/discharge changed by approach of an object, an accumulation process of accumulating the characteristics repeatedly extracted by the characteristic extraction process, an analog/digital conversion process of performing analog/digital conversion on the characteristics, a post-processing process of calculating approach or a position of the object from an output of the analog/digital conversion process, a control process of managing an overall state and sequence, and an abnormality detection process. The abnormality detection process receives an input from the characteristic extraction process and determines whether or not the output is abnormal. Thereafter, it is controlled in such away that the abnormal value is not output as a detection value to the accumulation analog/digital conversion means when the output is abnormal. As necessary, the charge/discharge process, the characteristic extraction process, the accumulation process, and the analog/digital conversion process are repeated a predetermined number of times.

An information apparatus according to the invention includes a case that protects the information apparatus, a display that outputs information, the electrostatic detection device of the invention that receives an input from a detection panel to specify approach or a position of an object, and a CPU that controls input from the electrostatic detection device and output to the display.

### Advantageous Effects of Invention

According to the invention, it is possible to realize the electrostatic detection device, the information apparatus, and the method thereof capable of further attenuating noise by relatively simple means or method.

### BRIEF DESCRIPTION OF DRAWINGS

FIG. 1 is a block diagram illustrating an electrostatic detection device according to Embodiment 1 of the invention.

FIG. 2 is a structural diagram illustrating an example of a detection panel according to the invention.

FIG. 3 is a circuit diagram illustrating an example of characteristic extraction means of Embodiment 1.

FIG. 4 is a timing chart illustrating an operation of the characteristic extraction means of Embodiment 1.

FIG. 5 is a circuit diagram illustrating a variable resistor of Embodiment 1.

FIG. 6 is a flowchart illustrating an electrostatic detection method of Embodiment 1.

FIG. 7 is a block diagram illustrating another configuration of the characteristic extraction means of Embodiment 1.

FIG. 8 is a conceptual diagram illustrating an example of an effect of Embodiment 1.

FIG. 9 is a conceptual diagram illustrating an example of an effect of Embodiment 1.

FIG. 10 is a block diagram illustrating an electrostatic detection device according to Embodiment 2 of the invention.

FIG. 11 is a block diagram of abnormality detection means of Embodiment 2.

FIG. 12 is a diagram illustrating a method of setting a threshold value of Embodiment 2.

FIG. 13 is a flowchart illustrating the electrostatic detection method of Embodiment 2.

FIG. 14 is a flowchart relating to an abnormality detection process of Embodiment 2.

FIG. 15 is a timing chart illustrating an operation of Embodiment 2.

FIG. 16 is a flowchart illustrating another electrostatic detection method of Embodiment 2.

FIG. 17 is a block diagram illustrating another configuration of Embodiment 2.

FIG. 18 is a block diagram of an electrostatic detection device of the prior art.

FIG. 19 is a diagram illustrating simulation of the effects of the invention.

FIG. 20 is a diagram illustrating an example of an information apparatus using the invention.

### DESCRIPTION OF EMBODIMENTS

Two preferred embodiments according to the invention are described hereinafter.

### Embodiment 1

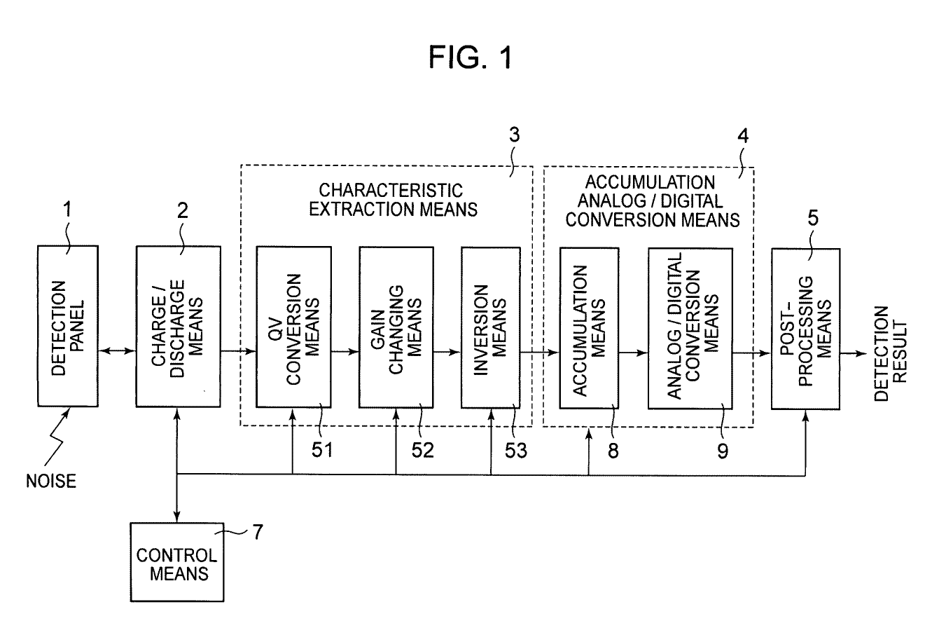

As shown in FIG. 1, an electrostatic detection device of Embodiment 1 according to the invention includes charge/discharge means 2 for repeatedly performing charge/discharge on detection electrodes of a detection panel 1, characteristic extraction means 3 for repeatedly extracting characteristics of charge/discharge changed by approach of an object, accumulation analog/digital conversion means 4 for accumulating the characteristics repeatedly extracted by the characteristic extraction means 3 and performing analog/digital conversion, post-processing means 5 for calculating approach or a position of the object from an output of the accumulation analog/digital conversion means 4, and control means 7 for managing an overall state and sequence. Herein, the characteristic extraction means 3 includes QV conversion means 51 for converting the characteristics of the charge/discharge in the charge/discharge means 2 into values, gain changing means 52 for changing a gain of the characteristic extraction means 3, and inversion means 53 for inverting an output of the gain changing means 52 synchronizing with an operation of the charge/discharge means 2.

An electrostatic detection method according to the invention includes a charge/discharge process 62 of repeatedly performing charge/discharge on each detection electrode of a detection panel 1, a characteristic extraction process 63 of extracting characteristics of charge/discharge changed by approach of an object, an accumulation analog/digital conversion process 64 of accumulating the characteristics extracted by the characteristic extraction process 63 and performing analog/digital conversion, a post-processing means 65 of calculating approach or a position of the object from an output of the accumulation analog/digital conversion process 64, and a control process of managing an overall state and sequence. Herein, the characteristic extraction means 63 includes a QV conversion process 71 of converting the characteristics of the charge/discharge in the charge/discharge process 62 into values, a gain changing process 72 of changing a gain of the characteristic extraction process 63, and an inversion process 73 of inverting an output of the gain changing process 72 synchronizing with an operation of the charge/discharge process 62. The charge/discharge process 62, the characteristic extraction process 63, and the accumulation analog/digital conversion process 64 are repeatedly operated.

Further, the invention will be described in detail with reference to FIG. 1 to FIG. 6.

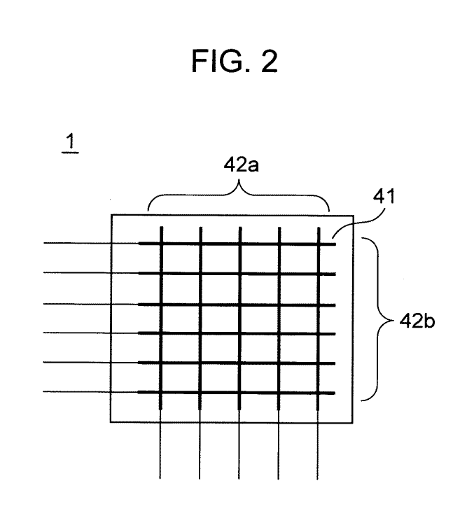

Herein, as shown in an example of FIG. 2, the detection panel 1 can detect approach of an object, and detection electrodes 42a and 42b disposed on a support substrate 41 are hereinafter referred to as detection electrodes 42 uniting the detection electrode 42a and the detection electrodes 42b. When the object approaches, the detection electrodes 42 or electrostatic capacitance between the detection electrode 42a and the detection electrode 42b are changed. Generally, a plurality of detection electrodes 42a and 42b are disposed corresponding to detected position coordinates to detect the approach and position of the object. However, when the number of disposed detection electrodes 42a and 42b is one, it is possible to detect only the approach of the object. In the charge/discharge means 2 or the charge/discharge process 62, the charge/discharge is repeatedly performed on the detection electrode 42. The characteristic extraction means 3 or the characteristic extraction process 63 extracts characteristics of the charge/discharge and extracts an influence of the approach of the object.

Herein, the reason for accumulating the characteristics of the repeated charge/discharge of a plurality of cycles is because change in electrostatic capacitance of the detection electrodes 42 or between the detection electrode 42a and the detection electrode 42b is gentle and because it is necessary to attenuate the influence of noise.

In characteristics corresponding to the electrostatic capacitance extracted by the characteristic extraction means 3 or the characteristic extraction process 63, characteristics corresponding to a plurality of times of charge/discharge are accumulated in the accumulation analog/digital conversion means 4 or the accumulation analog/digital conversion process 64 and are converted into digital values. The accumulation means 8 or the accumulation process 68 is provided to accumulate the characteristics corresponding to the charge/discharge of a plurality of times to remove noise, which is generally accumulated in capacitors. Herein, it is needless to say that an accumulation precision degree can be improved using an operation amplifier or the like. Voltage of accumulated capacitors is converted into a digital value by an analog/digital converter that is the analog/digital conversion means 9.

The accumulation analog/digital conversion means 4 or the accumulation analog/digital conversion process 64 performs accumulation using, for example, a delta sigma-type analog/digital converter or the like and performs the conversion into the digital values, and can be realized by uniting the accumulation means 8 and the analog/digital conversion means 9 or the accumulation process 68 and the analog/digital conversion process 69.

In the post-processing means 5 or the post-processing process 65, the approach or a position of the object to the detection panel 1 is acquired by the digital value from the accumulation analog/digital conversion means 4 or the accumulation analog/digital conversion process 64. For example, in the post-processing means 5 or the post-processing process 65, first, as necessary, conversion into values corresponding to change in electrostatic capacitance caused by the approach of the object is performed by further removing noise by a filter processor the like or by subtracting a value of a case where the object does not approach as offset. Next, when the change is larger than a certain value, it may be determined as the approach of the object to acquire the position of the approaching object.

Characteristics of Embodiment 1 will be described in detail.

A difference from the electrostatic detection device and the electrostatic detection method using the same in the prior art is that the characteristic extraction means 3 is provided with the gain changing means 52, the characteristic extraction process 63 is provided with the gain changing process 72, and a gain of characteristic extraction is changed synchronizing with charge/discharge. That is, as shown in FIG. 1, the characteristic extraction means 3 is formed by the QV conversion means 51, the gain changing means 52, and the inversion means 53, and the characteristic extraction process 63 is realized by the QV conversion process 71, the gain changing process 72, and the inversion process 73.

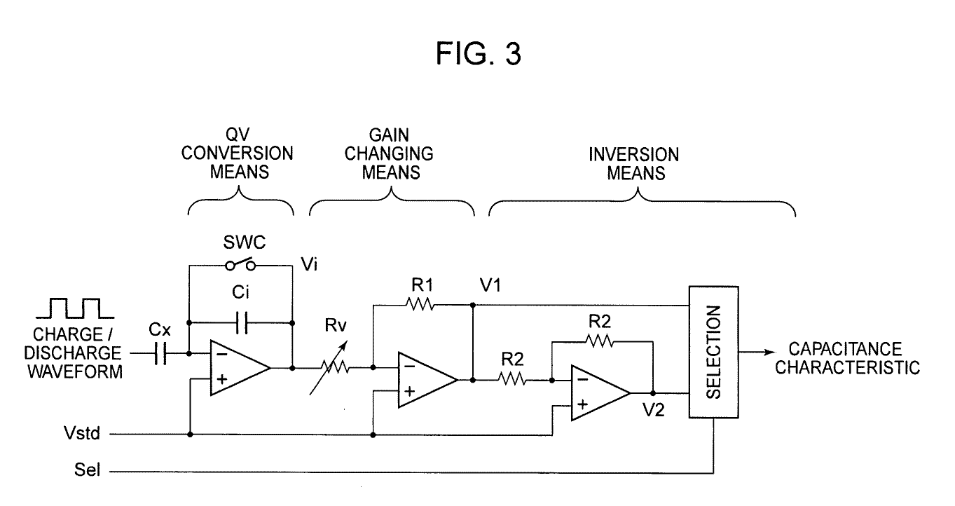

FIG. 3 is an example of a circuit of the characteristic extraction means 3 when the characteristic extraction means 3 is configured in order of the QV conversion means 51, the gain changing means 52, and the inversion means 53. In FIG. 3, a charge/discharge waveform is applied from one side of electrostatic capacitance Cx, corresponding to electrostatic capacitance between the detection electrode 42a and the detection electrode 42b. The other side of the electrostatic capacitance Cx is connected to the QV conversion means 51, and electric charges flowing into corresponding to a value of the electrostatic capacitance Cx are integrated by an integration circuit formed by an operation amplifier virtually installed with a voltage Vstd and are converted into voltage values. An output of the QV conversion means 51 is amplified by the operation amplifier in the gain changing means 52 using a variable resistor Rv. Specifically, the variable resistance Rv may be configured to select a resistor with a different value by a switch as shown in FIG. 5(a), and to make the same operation such that a resistance value is substantially changed by a time to turn on a switch connected to a resistor in series as shown in FIG. 5(b). The value of the variable resistor Rv is controlled by the control means 7, and thus a gain is changed synchronizing with the repeated charge/discharge. An output of the gain changing means 52 is configured such that in the inversion means 53, a signal which is inverted and a signal which is not inverted are alternately selected synchronizing with the charge/discharge by a selection circuit.

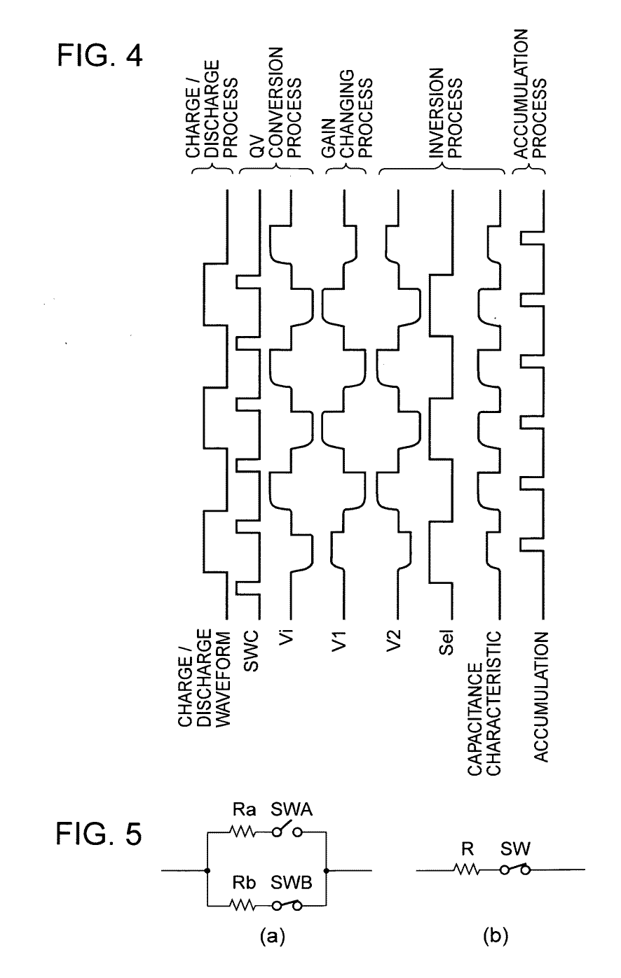

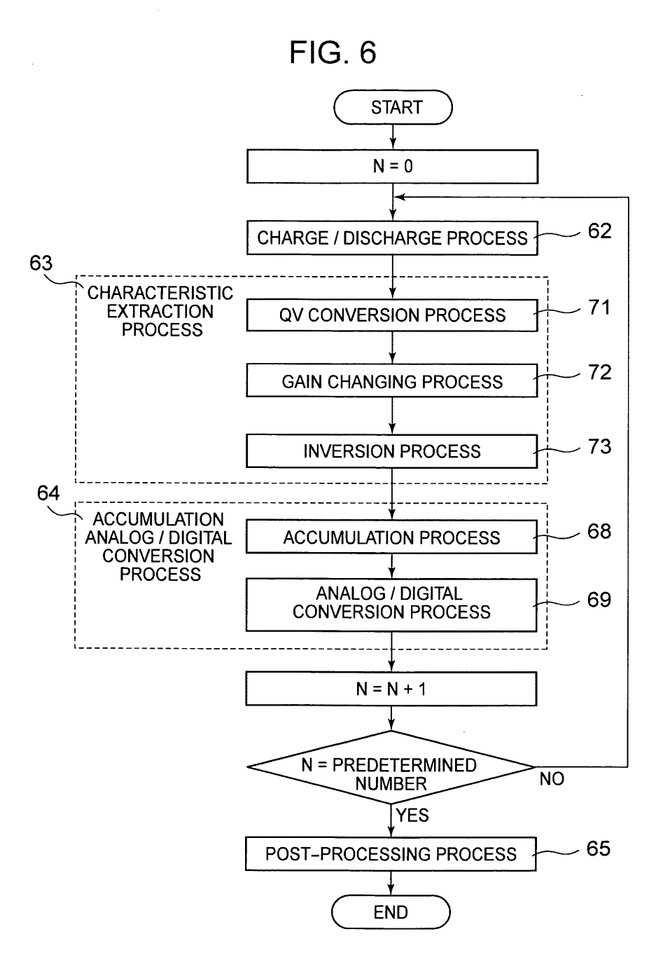

An example of the characteristic extraction process 63 operating the circuit configuration of FIG. 3 will be described with reference to FIG. 4 and FIG. 6. In FIG. 4, a horizontal axis is a common time axis.

The charge/discharge waveform is a rectangular wave with a duty ratio of 50% formed by the charge/discharge process 62. In addition, FIG. 4 concerns charge/discharge of 3 cycles for convenience, but it is needless to say that it is not limited to this.

FIG. 4 will be described.

The charge/discharge waveform is an alternating current waveform having 2 values of a LOW state and a HIGH state.

A waveform of SWC indicates switching on/off of the switch SWC, and a pulse-phases waveform is periodically generated even before change of the charge/discharge waveform. When the switch SWC is turned on, both ends of a capacitor Ci of the QV conversion process 71 are short-circuited, and a voltage value Vi is initialized.

A waveform of Vi indicates a voltage waveform Vi obtained by integrating electric charges flowing in the QV conversion means 51. Since the voltage waveform Vi is inverted by the operation amplifier, the voltage waveform is changed to a negative value when the charge/discharge waveform rises, and the voltage waveform is changed to a positive value when the charge/discharge waveform falls. A constant value is gradually approached with the lapse of time along with the rising time and falling time. The voltage waveform Vi is initialized by the switch SWC. A delay of the waveform is formed by wiring resistance and electrostatic capacitance of the detection electrodes 42.

A waveform of V1 indicates a half value of voltage corresponding to the first rising and the last falling of the charge/discharge waveform in the gain changing process 72. The voltage waveform is also inverted by the operation amplifier.

A waveform of V2 indicates a voltage waveform V2 obtaining the value of the voltage waveform V1 by the inversion process 73.

A waveform of Sel indicates a Sel signal of selecting the signal V1 before the inversion and the inverted signal V2. The Sel signal has 2 values of on and off, the signal V1 which is not inverted is selected in the on-state, and the inverted signal V2 is selected in the off-state. In the embodiment, the Sel signal is used such that the selected voltage waveform is positive.

As for a waveform of capacitance characteristics, any one of the voltage waveform V1 and the voltage waveform V2 is selected on the basis of the Sel signal, a voltage waveform indicating capacitance characteristics in which voltage change is always the same polarity is generated.

An accumulation waveform indicates a timing of accumulating by the accumulation means 8, and accumulation at the point in time when the voltage waveform indicating the capacitance characteristics output by the characteristic extraction process 63 is stable.

FIG. 6 will be described. FIG. 6 is a flowchart illustrating an example of the electrostatic detection method.

First, N indicating the number of repeated times is set to a 0-state. Subsequently, in the charge/discharge process 62, charge/discharge is performed on the detection electrodes 42 of the detection panel 1 having the detection electrodes 42. After the charge/discharge process 62, in the characteristic extraction process 63, characteristics of charge/discharge changed by approach of the object are extracted. In the accumulation analog/digital conversion process 64, the characteristics extracted by the characteristic extraction process 63 are accumulated in the accumulation process 68, and are converted from analog into digital by the analog/digital conversion process 69.

Next, an increment of 1 is performed on N indicating the number of repeated times, and then it is determined whether or not N satisfies a predetermined number that is the number of preset repetition times. When N is equal to or less than the predetermined number, the flow is returned to the charge/discharge process 62, and the operation is repeatedly performed. When N reaches the predetermined number, the process proceeds to the post-processing process 65.

Thereafter, in the post-processing process 65, the approach or position of the object is acquired on the basis of the output of the analog/digital conversion process 69.

In addition, although not shown, the overall state and sequence is managed by the control process. The electrostatic detection is performed through the above-described processes.

The characteristic extraction process 63 includes the QV conversion process 71 of converting the charge/discharge characteristics in the charge/discharge process 62 into values, the gain changing process 72 of changing a gain of the QV conversion process 71, and the inversion process 73 of inverting the output of the gain changing process 72 synchronizing with the operation of the charge/discharge process 62.

In addition, in the characteristic extraction process 63, the other of characteristics corresponding to rising and falling of the charge/discharge waveform is inverted and selected, thereby performing synthesis.

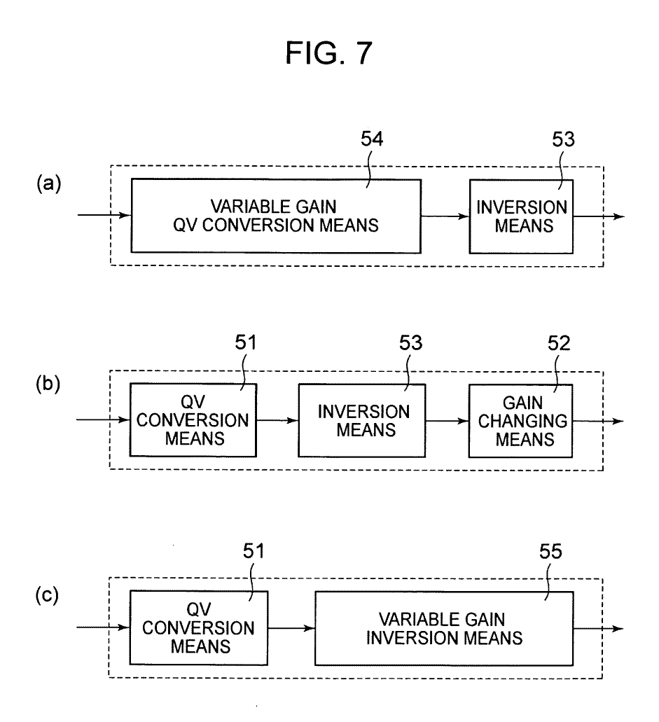

As described above, the example in which the characteristic extraction means 3 is configured in order of the QV conversion means 51, the gain changing means 52, and the inversion means 53, and the characteristic extraction process 63 is configured in order of the QV conversion process 71, the gain changing process 72, and the inversion process 73 has been described, but the characteristic extraction means 3 or the characteristic extraction process 63 is not limited to this. The value of the capacitor of the QV conversion means 51 is made variable, or as shown in FIG. 7(a), for example, the QV conversion means 51 or the QV conversion process 71 and the gain changing means 52 or the gain changing process 72 may be integrated into the variable gain QV conversion means 54 or the variable gain QV process. In addition, as shown in FIG. 7(b), the gain changing means 52 or the gain changing process 72 and the inversion means 53 or the inversion process 73 may be replaced, and as shown in FIG. 7(c), the gain changing means 52 or the gain changing process 72 and the inversion means 53 or the inversion process 73 may be integrated into the variable gain inversion process or the variable gain inversion means 55.

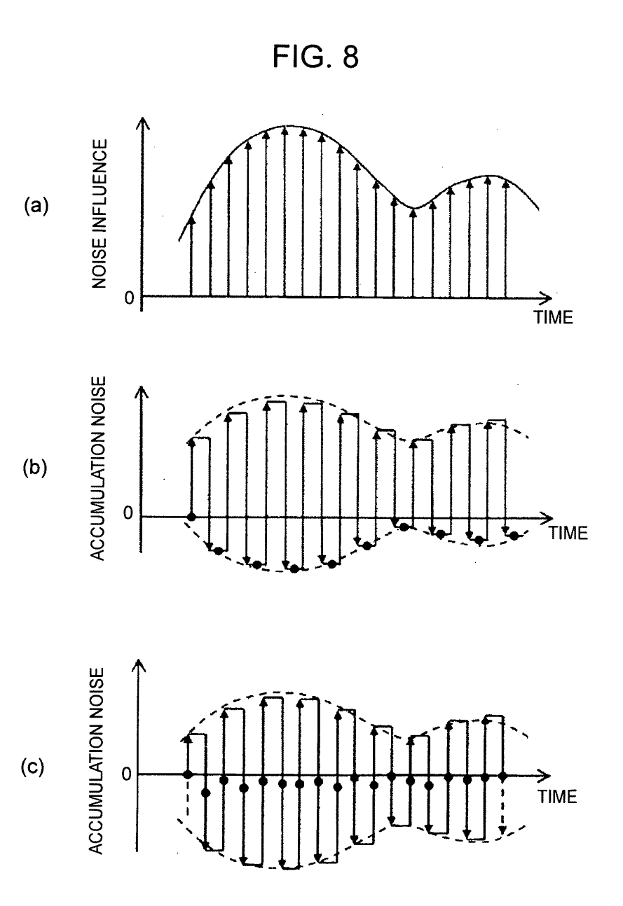

From this, an operation and an effect of the invention will be described with reference to FIG. 8. In FIG. 8, a horizontal axis is a common time axis in FIGS. 8(a), 8(b), and 8(c).

In FIG. 8(a) a vertical axis indicates intensity of an influence of noise, and a curve indicates time change of the intensity of the influence of noise. Vertical arrows of FIG. 8(a) indicate the magnitude of noise of the timing when the characteristic extraction corresponding to rising and falling of the charge/discharge waveform is performed. In this example, the time from the characteristic extraction corresponding to rising to the characteristic extraction corresponding to falling is the same as the time from the characteristic extraction corresponding to falling to the characteristic extraction corresponding to rising.

FIG. 8(b) indicates an influence of noise accumulated by the accumulation means 8 or the accumulation process 68 in the electrostatic detection device and the electrostatic detection method using the same in the prior art without the gain changing means 52 and the gain changing process 72. Directions of the arrows are alternatively inverted by an operation of the inversion means 53 or the inversion process 73. A black circle mark in the figure indicates the magnitude of noise accumulated for each charge/discharge of one cycle. Since it is alternatively inverted corresponding to rising and falling of the charge/discharge, it is needless to say that the influence of noise is more drastically reduced than the case of accumulating the influence of noise without inversion, but it is not necessarily sufficient.

In contrast, in the invention, as shown in FIG. 8(c), the first and last gains are about a half. Accordingly, the first and last influences of noise also become about a half. Herein, a black circle mark is the mid-point of each arrow, and is magnitude of the accumulation noise when it is assumed that the accumulation is ended at the timing.

The magnitude of the accumulation noise indicated by the black circle mark in FIG. 8(c) becomes clearly smaller than the magnitude of the accumulation noise indicated by the black circle mark in FIG. 8(b).

This is easily understood by thinking that two doted lines substantially enveloping the accumulation noise up and down are substantially symmetrical up and down, the black circle mark in FIG. 8(b) of the prior art is changed substantially along the line enveloping the downside, on the contrary, the black circle mark in FIG. 8(c) according to the invention is positioned substantially at the center of the line enveloping the upside and the downside, thus the change is small, and the influence of noise is effectively removed. In addition, the reason why the two dotted lines substantially enveloping the accumulation noise up and down are substantially symmetrical up and down is because the time from the rising arrow to the falling arrow is the same as the time from the falling arrow to the rising arrow, and degrees of change are substantially the same.

FIG. 19 shows the effect of the advantages of the invention calculated by simulation. A horizontal axis is a frequency, and a vertical axis is an attenuation rate of noise. A characteristic of a dotted line in the figure is a characteristic when characteristics corresponding to rising and characteristics corresponding to falling are accumulated by the method of the prior art shown in FIG. 8(b), and a characteristic of a solid line in the figure is a characteristic when the first and the last gains are halved using the invention shown in FIG. 8(c), from which it is known that noise is effectively attenuated.

In addition, according to the invention, as can be seen from the positions of the black circles of FIG. 8(c), a plurality of cycles of rising and falling of the charge/discharge waveform do not necessarily have to be repeated, the accumulation may be completed starting from rising and ending with falling, the accumulation may be completed starting from falling and ending with falling, and of course, the accumulation may be completed starting from falling and ending with rising.

As described above, the case where the time from rising to falling of the charge/discharge waveform is the same as the time from falling to rising and the duty ratio is 50% has been described.

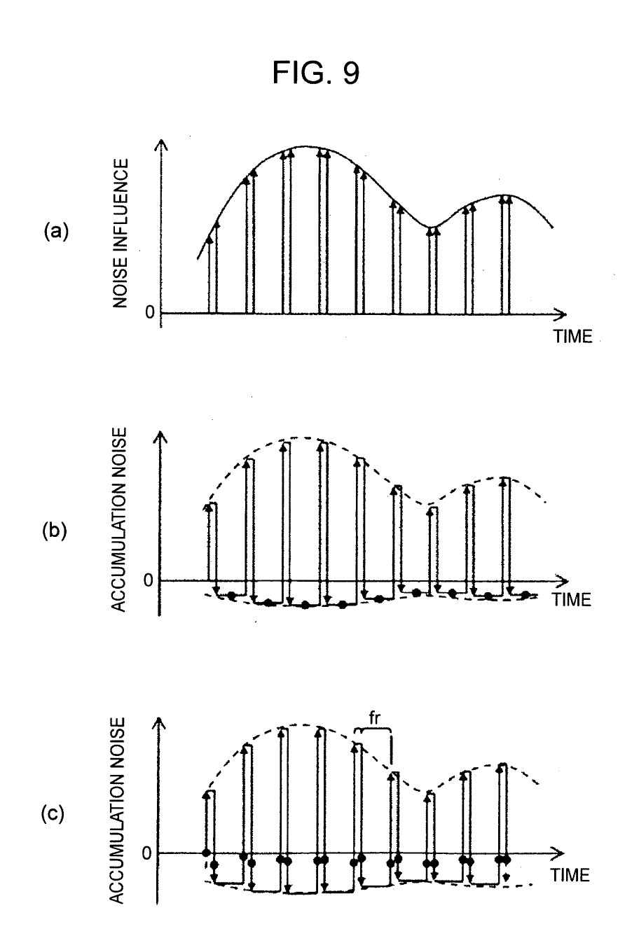

From this, a case of a more general charge/discharge waveform in which the duty ratio is not 50% will be described with reference to FIG. 9 in the same manner as the case of FIG. 8. As a specific example in which the duty ratio is not the general 50%, there may be a case where analog/digital conversion is operated after the characteristic extraction of one cycle.

FIG. 9(a) shows the influence of noise at the timing of characteristic extraction by a magnitude of arrows in the same manner as FIG. 8(a).

FIG. 9(b) shows the influence of noise accumulated by the accumulation means 8 or the accumulation process 68 in the electrostatic detection device and the electrostatic detection method using the same in the prior art without the gain changing means 52 and the gain changing process 72 in the same manner as FIG. 8(b). As the timing of characteristic extraction corresponding to rising of the charge/discharge waveform gets closer to the timing of characteristic extraction corresponding to falling, the accumulation noise gets smaller. When the characteristic extraction can be performed substantially at the same time, the influence of noise is canceled out by reciprocal noise so as to be substantially removed. However, actually, a time is taken in delaying the waveform, the characteristic extraction, and the accumulation in the electrodes of the detection panel 1. For this reason, generally, the characteristic extraction cannot be performed at the same time, and the noise cannot necessarily be attenuated sufficiently.

FIG. 9(c) shows that the first and last gains of the gain changing means 52 or the gain changing process 72 are made small in the same manner as FIG. 8(c), and the noise accumulated by the accumulation means 8 or the accumulation process 68 is effectively attenuated.

Herein, a time from the first characteristic extraction of the charge/discharge to the next characteristic extraction of the reverse-phase charge/discharge is f, and a time from the characteristic extraction of the reverse-phase charge/discharge to the next characteristic extraction is r, which are repeated. Generally, the time f corresponds to a time from an anterior edge to a posterior edge of the charge/discharge waveform, and the time r corresponds to a time from a posterior edge to an anterior edge of the charge/discharge.

FIG. 9(c) is an example when the influence of noise at the anterior edge is indicated by a rising arrow, and the influence of noise at the posterior edge is indicated by a falling arrow. It is needless to say that it is not limited to this. In this case, temporary change of a dotted line substantially enveloping the accumulation noise up is substantially in proportion to the time r from the posterior edge to the anterior edge. As for noise of low frequency, as the time gets longer, the change of the influence of noise gets larger. Similarly, change of a dotted line substantially enveloping the accumulation noise down is substantially in proportion to the time f from the anterior edge to the posterior edge.

For this reason, the gain in the gain changing means 52 of the characteristic extraction means 3 corresponding to the first charge/discharge (anterior) is R times a general gain. As for the last gain of the gain changing means 52 of the characteristic extraction means 3, it is F times the general gain in a case of the anterior edge, and it is R times the general gain in a case of the posterior edge. However, these coefficients F and R are represented by Formula 1 and Formula 2.

F=f/(f+r) (Formula 1)

R=r/(f+r) (Formula 2)

As described above, by setting the gain in the gain changing means 52, even when the accumulation is ended at any timing, the accumulation noise is indicated at the position of the black circle of FIG. 9(c), and thus it is possible to effectively attenuate the accumulation noise. In addition, since it is generally difficult to greatly change the duty ratio of the charge/discharge waveform from 50% by the delay time in the detection panel 1, it is effective that only the first gain and the last gain are set in the range of 0.2 times or more and 0.8 times or less. It is needless to say that such gains are programmably changed to arbitrary values for compatibility of a circuit.

When the duty ratio of the charge/discharge waveform is changed mid-way, it is preferable that the first and last gains are set for each duty ratio such that the accumulation noise becomes small.

### Embodiment 2

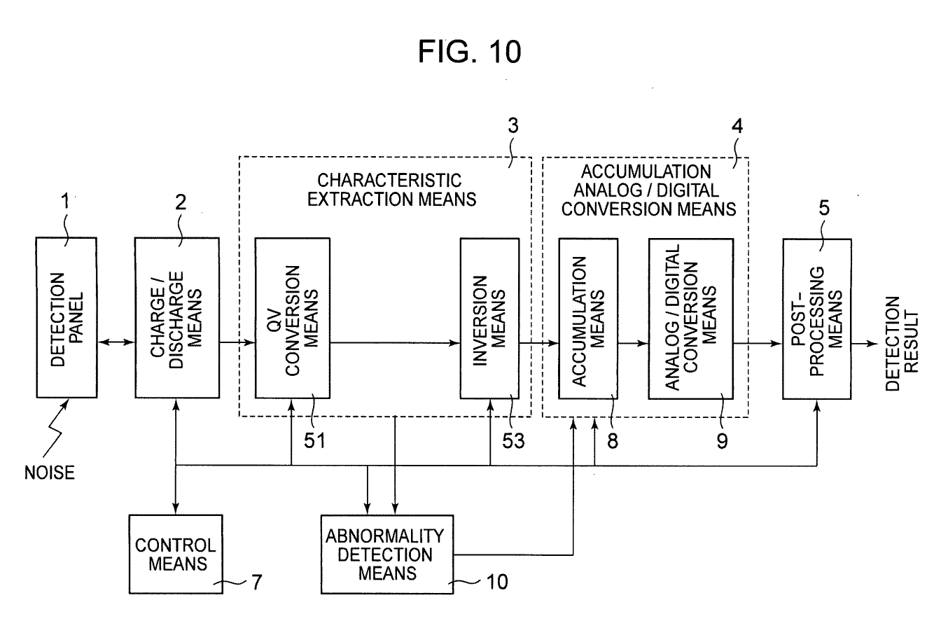

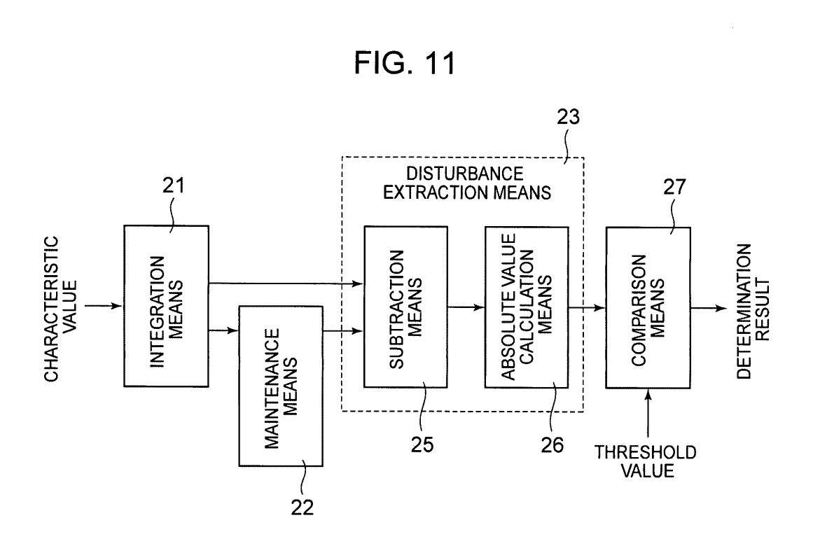

Embodiment 2 of the invention will be described with reference to FIG. 10 and FIG. 11.

FIG. 10 is a block diagram of an electrostatic detection device according to the invention. The electrostatic detection device includes a detection panel 1 having a plurality of detection electrodes 42, charge/discharge means for repeatedly performing charge, discharge, or charge/discharge on the detection electrodes 42 of the detection panel 1, characteristic extraction means 3 for repeatedly extracting characteristics of charge, discharge, or charge/discharge changed by approach of an object, accumulation analog/digital conversion means 4 for accumulating the characteristics repeatedly extracted by the characteristic extraction means 3 and performing analog/digital conversion, post-processing means 5 for calculating approach or a position of the object from an output of the accumulation analog/digital conversion means 4, abnormality detection means 10 for controlling the repeated operation of the analog/digital conversion means 9 according to whether or not there is abnormality in an output of the characteristic extraction means 3, and control means 7 for managing an overall state and sequence. When the accumulation analog/digital conversion means 4 receives a signal indicating abnormality from the abnormality detection means 10, it avoids an influence of the abnormal value such that the characteristic values determined as abnormal are not accumulated by the accumulation means 8.

The characteristic extraction means 3 includes QV conversion means 51 for converting the characteristic of the charge/discharge in the charge/discharge means 2 into values, and inversion means 53 for inverting an output of the QV conversion means 51 synchronizing with an operation of the charge/discharge means 2.

FIG. 11 is a block diagram of the abnormality detection means 10. The abnormality detection means 10 includes integration means 21, maintenance means 22, disturbance extraction means 23, and comparison means 27, and determines there is an abnormality when a noise larger than general is applied.

Herein, in the integration means 21, there are many cases where noise from the outside is applied in the same manner as all the detection electrodes 42. The integration means 21 integrates characteristics from the characteristic extraction means 3 corresponding to the plurality of detection electrodes 42, and may be provided as necessary. For example, they may be averaged by integrating into one signal through resistors, or may be summed by an operation amplifier or an operation.

The maintenance means 22 maintains a value output from the integration means 21 corresponding to the previous charge/discharge. For example, characteristic values detected corresponding to, for example, one previous time of repeated charge/discharge are maintained in a sample-hold circuit, storage means, or the like. Alternatively, fluctuation factors may be removed from the detected values by a filter or the like to maintain an average value.

The disturbance extraction means 23 extracts characteristic values corresponding to the present charge/discharge output by the integration means 21, and characteristic values corresponding to charge/discharge before the outputting of the maintenance means 22, an extent of influence of noise included in the characteristic of the charge/discharge. For example, an absolute value of a difference between the characteristic values corresponding to the present charge/discharge and the characteristic values maintained by the maintenance means 22 is acquired.

The comparison means 27 compares the absolute value with a predetermined threshold value or a threshold value determined by means to be described later on the basis of the absolute value of the difference of the characteristic values obtained by the disturbance extraction means 23, to determine whether or not there is abnormality as compared with the threshold value. An output from the comparison means 27 is a value indicating two values of abnormality or normality.

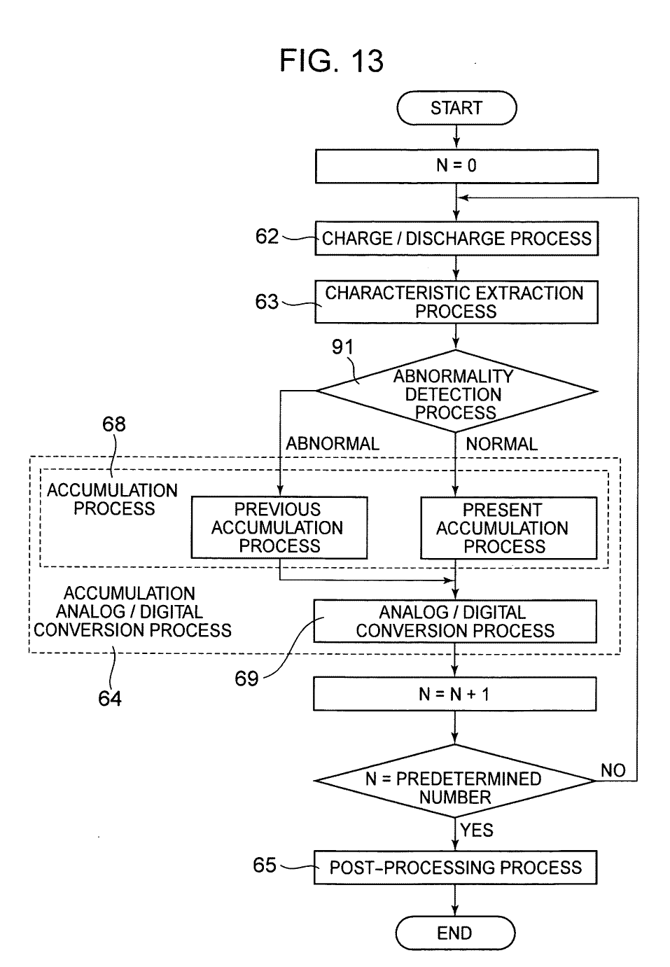

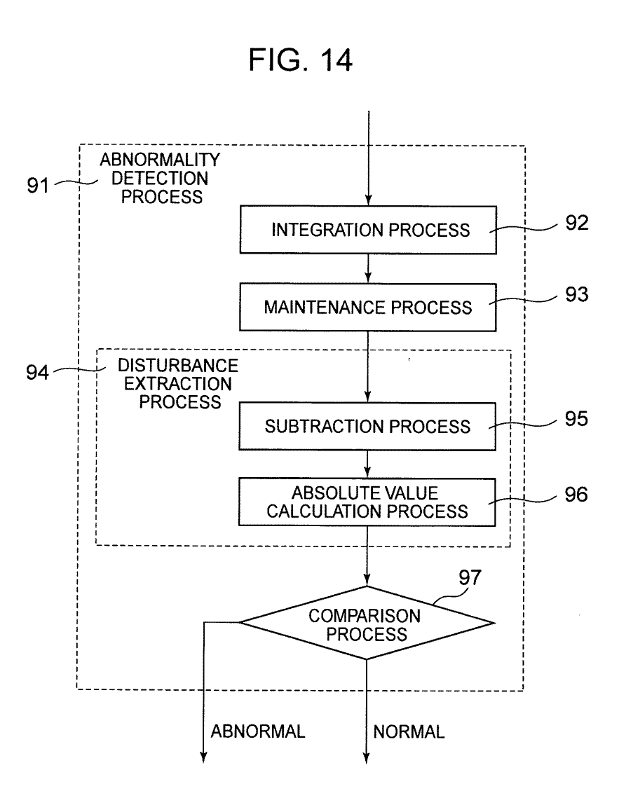

An electrostatic detection method of Embodiment 2 according to the invention will be described with reference to flowcharts of FIG. 13 and FIG. 14.

One configuration of Embodiment 2 is shown in FIG. 13.

First, N indicating the number of repetition times is set to a 0-state. Subsequently, in the charge/discharge process 62, charge/discharge is performed on the detection electrodes 42. After the charge/discharge process 62, characteristics of the charge/discharge changed by approach of the object are extracted in the characteristic extraction process 63. Then, it is determined whether or not there is abnormality on the basis of the characteristics extracted by the characteristic extraction process 63 in the abnormality detection process 91. When it is determined as normal, the characteristics extracted by the present accumulation process in the accumulation process 68 are accumulated. When it is determined as abnormal, characteristics of the time just previous which are not the present characteristics and are not abnormal are accumulated by a previous-time accumulation process in the accumulation process 68.

Subsequently, in the digital/analog conversion process 69, analog/digital conversion is performed on the basis of the characteristic values obtained by the characteristic extraction process 63. Then, increment of 1 is performed on N indicating the number of repetition times, and then it is determined whether or not N satisfies a predetermined number that is a preset number of repetition times. When N is equal to or less than the predetermined number, the flow is returned to the charge/discharge process 62, and the operation is repeatedly performed. When N reaches the predetermined number, the process proceeds to the post-processing process 65. The approach or a position of the object is acquired from the output of the analog/digital conversion process 69 in the post-processing process 65. In addition, although not shown, the overall state and sequence is managed by the control process. The electrostatic detection is performed through the above-described processes.

Although not shown in FIG. 13, the characteristic extraction process 63 includes the QV conversion process 71 of converting the charge/discharge characteristics in the charge/discharge process 62 into values, and the inversion process 73 of inverting the gain obtained by the previous process synchronizing with the operation of the charge/discharge process 62. However, the sequence of these QV conversion process 71 and inversion process 73 may be replaced.

In addition, the accumulation process 68 and the analog/digital conversion process 69 are together called the accumulation analog/digital conversion process 64.

The abnormality detection process 91 is shown in detail in FIG. 14.

In the abnormality detection process 91, inputs from the characteristic extraction process 63 are integrated in the integration process 92. Then, signals obtained by the integration process 92 are maintained in the sample-hold circuit, the storage means, or the like in the maintenance process 93. Subsequently, subtraction relating to disturbance is performed by the subtraction process 95, and it is converted into a value with a predetermined polarity such as an absolute value of change in the absolute value calculation process 96 or an absolute value of deviation. Thereafter, it is compared with a predetermined threshold value on the basis of the output from the absolute value calculation process 96 in the comparison process 97. In the comparison process 97, when the output from the absolute value calculation process 96 is lower than the threshold value, it is determined as normal. In the comparison process 97, when the output from the absolute value calculation process 96 is higher than the threshold value, it is determined as abnormal. After performing the normal or abnormal determination, the processes are performed along the flow shown in FIG. 13.

From this, means and processes will be described in detail on the basis of the configuration of FIG. 10 and FIG. 13.

Herein, as shown in the example of FIG. 2, the detection panel 1 can detect the approach of the object from the detection electrodes 42 disposed on the support substrate 41. When the object approaches, the detection electrodes 42 or electrostatic capacitance between the detection electrodes 42 are changed. Generally, a plurality of detection electrodes 42 are disposed to detect the approach or a position of the object. However, when the number of disposed detection electrode 42 is one, it is possible to detect only the approach of the object. In the charge/discharge means 2 or the charge/discharge process 62, the charge/discharge is repeatedly performed on the detection electrode 42. The characteristic extraction means 3 or the characteristic extraction process 63 extracts characteristics of the charge/discharge and extracts an influence of the approach of the object.

As described above, in the characteristics corresponding to the electrostatic capacitance extracted by the characteristic extraction means 3 or the characteristic extraction process 63, characteristics corresponding to a plurality of times charge/discharge are accumulated in the accumulation means 8 or the accumulation process 68, and are converted into digital values in the analog/digital conversion means 9 or the analog/digital conversion process 69. The accumulation means 8 or the accumulation process 68 is for accumulating the characteristics corresponding to the charge/discharge of a plurality of times to remove noise, which is generally accumulated in capacitors. Herein, it is needless to say that an accumulation precision degree can be improved using an operation amplifier or the like. Voltage of accumulated capacitors is converted into a digital value by an analog/digital converter of the analog/digital conversion means 9 or the analog/digital conversion process 69.

The accumulation is performed using, for example, a delta sigma-type analog/digital converter or the like and the conversion into the digital values is performed, and it is possible to unite the accumulation means 8 and the analog/digital conversion means 9 or the accumulation process 68 and the analog/digital conversion process 69.

In the post-processing means 5 or the post-processing process 65, the approach or a position of the object to the detection panel 1 is acquired by the digital value from the analog/digital conversion means 9 or the analog/digital conversion process 69. For example, in the post-processing means 5 or the post-processing process 65, first, as necessary, conversion into values corresponding to change in electrostatic capacitance caused by the approach of the object is performed by further removing noise by a filter process or the like or by subtracting a value of a case where the object does not approach as offset. Next, when the change is larger than a certain value, it may be determined as the approach of the object and acquire the position of the approaching object.

The control means 7 or the control process manages the overall state or sequence. For this reason, it is controlled to be sequentially operated synchronizing with the above-described processes.

The detection panel 1, the charge/discharge means 2, the characteristic extraction means 3, the analog/digital conversion means 9, the post-processing means 5, and the control means 7, or the charge/discharge process 62, the characteristic extraction process 63, the analog/digital conversion process 69, the post-processing process 65, and the control process are substantially the same as the electrostatic detection device or the method thereof in the prior art. In Embodiment 2 according to the invention, there is a characteristic that the abnormality detection means 10 or the abnormality detection process 91 of detecting whether or not abnormal noise is applied to the output of the characteristic extraction means 3 or the characteristic extraction process 63 is provided, such that they are not accumulated by the accumulation means 8 or the accumulation process 68 in the abnormal case. For this reason, the voltage extracted by the characteristic extraction means 3 or the characteristic extraction process 63 is temporarily maintained by the sample-hold circuit until it is detected and accumulated as characteristics corresponding to the electrostatic capacitance of about one charge/discharge.

In the invention, generally, since a period of charge/discharge is a high rate from several tens of kHz to several MHz, it monitors the characteristic values detected by the characteristic extraction means 3 or the characteristic extraction process 63 by movement of the detection target object are not greatly changed for each charge/discharge, and thus it monitors so that abnormally large change can be detected as noise.

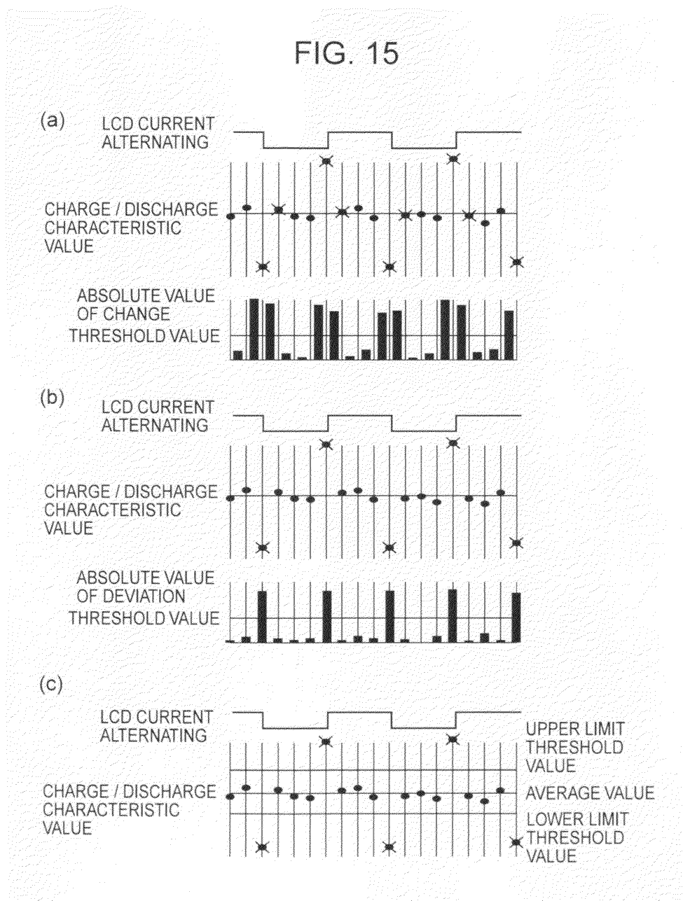

In FIG. 15(a), LCD current alternating indicates a periodically changed rectangular wave, and the charge/discharge characteristic value indicates the characteristic value extracted from the characteristic extraction means 3. In the example of FIG. 15, a state where there is no input from the outside such as a finger is shown, and thus the charge/discharge characteristic value is basically in the vicinity of 0. However, in the LCD current alternating, the charge/discharge characteristic value is greatly changed according to the timing when change of voltage occurs. The absolute value of the change indicates an absolute value of the amount of change of the charge/discharge characteristic value. The absolute value of the change is affected by the change in the LCD current alternating. Herein, a regular threshold value is set to determine whether or not the value is over the threshold value. In the example of the figure, the timing when it is over the threshold value is indicated on the charge/discharge characteristic value by an × mark. That is, it indicates a measurement point contributing to the absolute value of the change.

FIG. 15(b) is an example in which a threshold value is provided for the absolute value of deviation. In FIG. 15(b), the LCD current alternating and the charge/discharge characteristic value are the same as FIG. 15(a). The absolute value and threshold value of deviation indicate deviation of the charge/discharge characteristic value. Unlike the absolute value and threshold value of change of FIG. 15(a), the timing when it is over a regular threshold value in the absolute value and threshold value of deviation coincides with the timing when the voltage is changed in the LCD current alternating.

As a particular difference between FIG. 15(a) and FIG. 15(b), the absolute value of change and the absolute value of deviation are different in timing of determining that it is over the threshold value. In the example shown in FIG. 15(a), since the previous-time value is maintained by the maintenance means 22, change from the previous time is extracted to perform the determination. On the contrary, in the example shown in FIG. 15(b), since a previous average value is maintained by the maintenance means 22, an absolute value of deviation of the characteristic values of the present charge/discharge is extracted to perform the determination.

For this reason, the disturbance extraction means 23 is configured by subtraction means 25 and absolute value calculation means 26, and the disturbance extraction process 94 is realized by a subtraction process 95 and an absolute value calculation process 96, such that an extent of influence of noise such as change and deviation is extracted, but it is not limited to this, and any means or process may be used as long as the extent of influence of noise included in the charge/discharge characteristics is extracted from characteristic values corresponding to the present charge/discharge output by the integration means 21 or the integration process 92 and the characteristic values corresponding to the charge/discharge before the outputting of the maintenance means 22 or the maintenance process 93.

In addition, after the comparison is confirmed, the characteristic values corresponding to the present charge/discharge are updated for determination of the next charge/discharge to be maintained by the maintenance means 22 or the maintenance process 93, or an average value thereof is updated. Herein, when it is determined as abnormal, the values maintained by the maintenance means 22 or the maintenance process 93 may not be updated, but in this case, consideration that the abnormality does not continue even in an initially abnormal case is especially necessary.

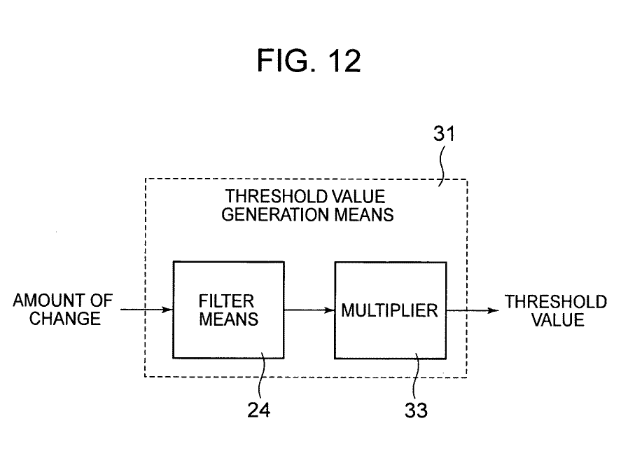

As the threshold value used in the comparison means 27 or the comparison process 97, a preset value may be used. As an additional method, for example, as shown in FIG. 12, an average noise level at the point in time, which can be obtained by filtering the amount of change output by the disturbance extraction means 23 by the filter means 24 of the threshold value generating means 31 may be dynamically changed by coefficient multiplication of a multiplier 33.

As described above, the example of the case configured to compare the absolute value of change or deviation with the threshold value by the abnormality detection means 10 or the abnormality detection process has been shown with reference to FIGS. 15(a) and (b), but a third example in the abnormality detection means 10 or the abnormality detection process will be described with reference to FIG. 15(c). In FIG. 15(c), similarly to FIGS. 15(a) and (b), LCD current alternating indicates a periodically changed rectangular wave, and the charge/discharge characteristic value indicates deviation from the average value. In the example of FIG. 15(c), instead of calculating the change of charge/discharge or the absolute value of deviation, an upper limit threshold value and a lower limit threshold value are provided as the threshold value, and it is determined as abnormal when the deviation of the characteristics of the charge/discharge is not between them. As for change, it is needless to say that the determination may be performed by the upper limit and the lower limit. As described above, the abnormality detection means 10 or the abnormality detection process may be configured in any manner as long as it is means or a process capable of detecting that characteristics of charge/discharge are abnormal.

As shown in FIG. 15 by × marks on the charge/discharge characteristic values for convenience, when the abnormality detection means 10 or the abnormality detection process 91 determines it as abnormal, the characteristic values maintained by the characteristic extraction means 3 or the characteristic extraction process 63 are not accumulated. In such a manner, for example, when a transparent detection panel 1 is used to overlap with a liquid crystal display device and even when noise even larger than other noise is periodically applied by current alternating of liquid crystal, the disuse of the characteristic values at that time is possible.

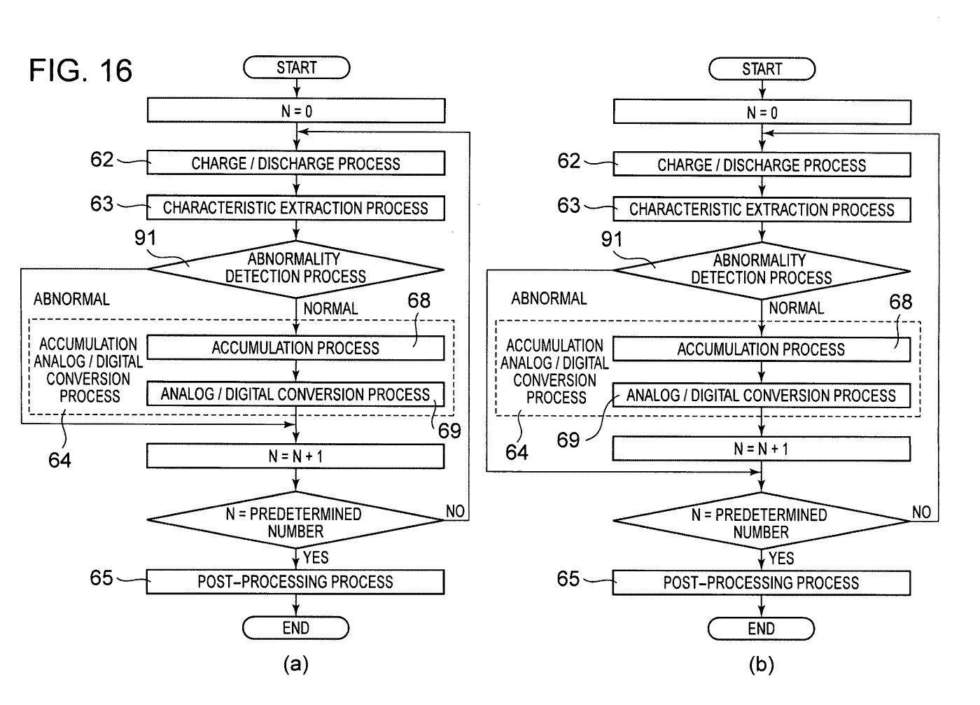

However, when it is determined as abnormal, the value subjected to analog/digital conversion becomes small such that, a converted digital value as is becomes small. As an example of flow of a processing method to avoid this, there may be two configurations of FIG. 16(a) and FIG. 16(b) in addition to the above description.

Another detection method of Embodiment 2 is shown in FIG. 16(a).

First, N indicating the number of repetition times is set to a 0-state. Subsequently, in the charge/discharge process 62, charge/discharge is performed on the detection electrodes 42. After the charge/discharge process 62, in the characteristic extraction process 63, characteristics of charge/discharge changed by approach of the object are extracted. In the abnormal detection process 91, it is determined whether or not the characteristics are abnormal on the basis of the characteristics extracted by the characteristic extraction process 63.

When it is determined as normal, in the accumulation analog/digital conversion process 64, the extracted characteristics are accumulated by the accumulation process 68, and analog/digital conversion is performed in the analog/digital conversion process 69.

When it is determined as abnormal, the accumulation analog/digital conversion process 64 is skipped.

Subsequently, N indicating the number of repetition times is subjected to increment by 1, and then it is determined whether or not N satisfies a predetermined number that is the number of preset repeated times. When N is equal to or less than the predetermined number, the flow is returned to the charge/discharge process 62, and the operation is repeatedly performed. When N reaches the predetermined number, the process proceeds to the post-processing process 65. In the post-processing process 65, the approach or a position of the object is acquired.

In addition, although not shown, the overall state and sequence is managed by the control process. The electrostatic detection is performed through the above-described processes.

In addition, although not shown, the characteristic extraction process 63 includes the QV conversion process 71 of converting the charge/discharge characteristics in the charge/discharge process 62 into values, and the inversion process 73 of inverting the gain obtained by the previous process synchronizing with the operation of the charge/discharge process 62. However, sequence of the QV conversion process 71 and inversion process 73 may be replaced.

When correction is performed by the post-processing process 65 as much as the number of times decreases, and thus 3 charge/discharges of, for example, 20 charge/discharges are determined as abnormal and the number of times of the analog/digital conversion is small, the converted digital value is corrected by 20/17 times.

Still another detection method of Embodiment 2 is shown in FIG. 16(b).

First, N indicating the number of repetition times is set to a 0-state. Subsequently, in the charge/discharge process 62, charge/discharge is performed on the detection electrodes 42. After the charge/discharge process 62, characteristics of the charge/discharge changed by approach of the object are extracted in the characteristic extraction process 63. Then, it is determined whether or not there is abnormality on the basis of the characteristics extracted by the characteristic extraction process 63 in the abnormality detection process 91.

When it is determined as normal, in the accumulation analog/digital conversion process 64, the extracted characteristics are accumulated by the accumulation process 68, analog/digital conversion is performed in the analog/digital conversion process 69, and increment of 1 is performed on N indicating the number of repetition times.

When it is determined as abnormal, increment (N=N+1) of counting the number of repetition times by the accumulation analog/digital conversion process 64 is skipped.

At all the normal time and the abnormal time, it is determined whether or not N satisfies a predetermined number that is the number of preset repetition times after the lapse of the predetermined flow. When N reaches the predetermined number, the process proceeds to the post-processing process 65. The approach or a position of the object is acquired from the output of the analog/digital conversion process 69 in the post-processing process 65. When N is equal to or less than the predetermined number, the flow is returned to the charge/discharge process 62, and the operation is repeatedly performed.

Although not shown, the characteristic extraction process 63 includes the QV conversion process 71 of converting the charge/discharge characteristics in the charge/discharge process 62 into values, and the inversion process 73 of inverting the gain obtained by the previous process synchronizing with the operation of the charge/discharge process 62. However, the sequence of the QV conversion process 71 and inversion process 73 may be replaced.

As shown in FIG. 16(b), once the output of the abnormality detection process 91 is input to the control process. When it is determined as abnormal, the accumulation in the analog/digital conversion process 69 is not performed, the process may be performed again from the charge/discharge.

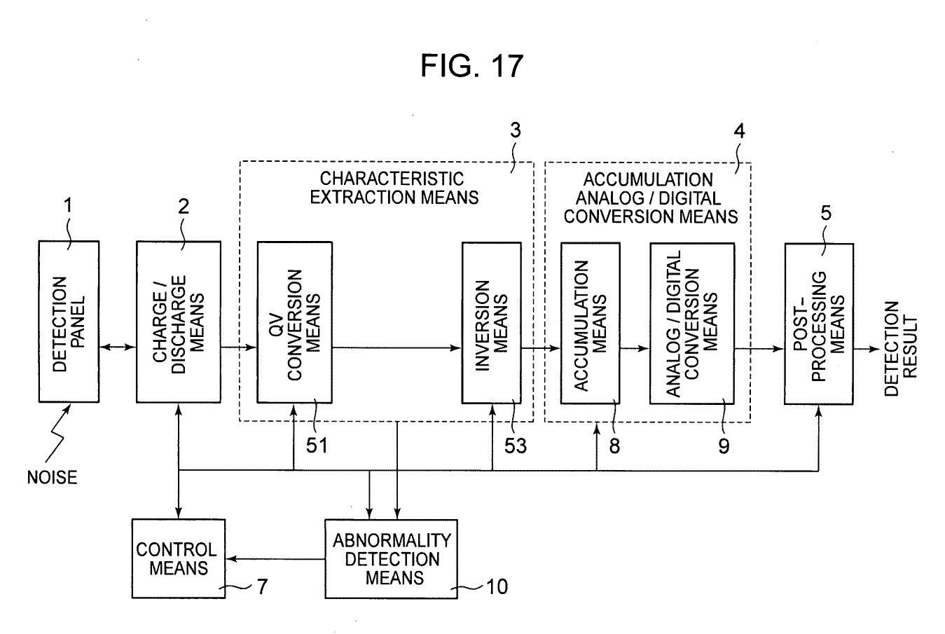

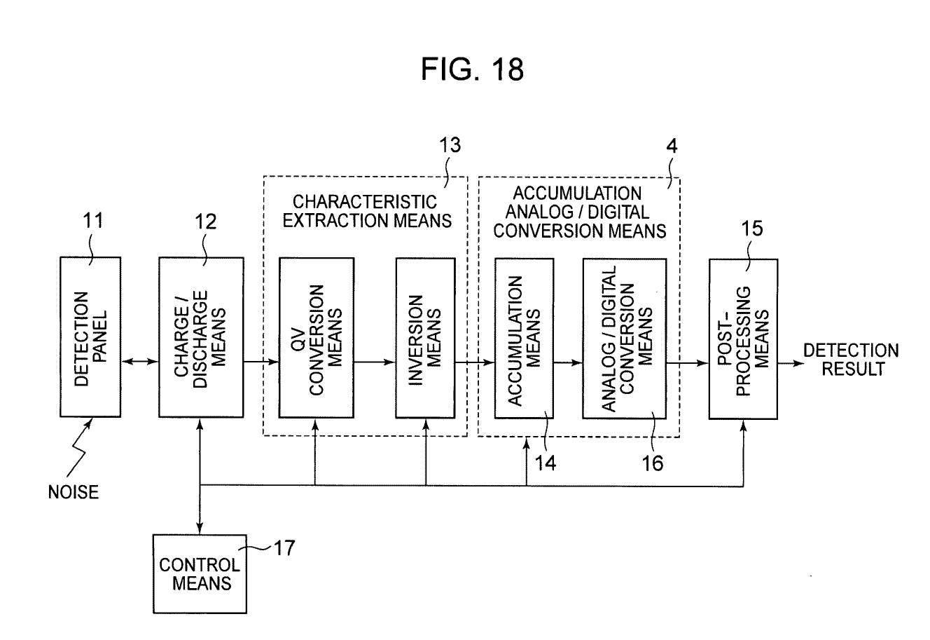

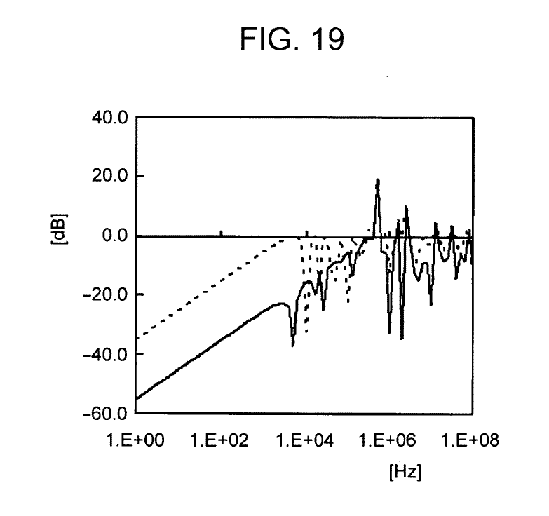

FIG. 17 is a block diagram illustrating another configuration of Embodiment 2. Means constituting FIG. 17 are the same as means constituting FIG. 10. The electrostatic detection device includes a detection panel 1 having a plurality of detection electrodes 42, charge/discharge means 2 for performing charge/discharge on the detection electrodes 42 of a detection panel 1, characteristic extraction means 3 for extracting characteristics of charge/discharge changed by approach of an object, accumulation means 8 for accumulating the characteristics extracted by the characteristic extraction means 3, analog/digital conversion means 9 for performing analog/digital conversion of the characteristics of the characteristic extraction means 3, post-processing means 5 for calculating approach or a position of the object from an output of the analog/digital conversion means 9, abnormality detection means 10 for controlling the operation of the analog/digital conversion means 9 according to whether or not there is abnormality in an output of the characteristic extraction means 3, and control means 7 for managing an overall state and sequence. In addition, the accumulation means 8 and the analog/digital conversion means 9 are together called the accumulation analog/digital conversion means 4.

A difference from the example of FIG. 10 is that a signal indicating abnormality is transmitted to the control means 7 when the abnormality detection means 10 determines it as abnormal, and noise of abnormal values is avoided by the control means 7 such that the characteristic values determined as abnormal are not accumulated.

As described above, in the electrostatic detection device and the method thereof in Embodiment 1, it is possible to realize the electrostatic detection device and the method thereof of efficiently attenuating noise of low frequency by adding the simple configuration and process.

In addition, also in the electrostatic detection device and the method thereof in Embodiment 2, by adding the simple configuration and process, when the characteristic value corresponding to the electrostatic capacitance is abnormally changed, it is possible to perform detection substantially with no influence so as not to use the characteristic values even when large noise is applied at unexpected timing.

In addition, in all the processes of Embodiment 1 and Embodiment 2, increment of 1 is performed on N indicating the number of repetition times, then it is determined whether or not N satisfies a predetermined number that is the number of preset repetition times, and then conversion may be performed by the analog/digital conversion process 69.

In addition, specific configuration or sequence of the detection panel 1, the charge/discharge means 2, the characteristic extraction means 3, or the charge/discharge process 62, and the characteristic extraction process 63 in the invention may be variously conceivable. Hereinafter, representative configuration or sequence will be described.

First, means or a method using change in electrostatic capacitance of the detection electrodes 42 themselves of the detection panel 1 called a load method will be described. In this case, one or a plurality of detection electrodes 42 are disposed in the detection panel 1, and individual detection electrodes 42 may be used as switches, they may be sequentially disposed to be used as sliders, or they may be 2-dimensionally disposed to be used as coordinate detection of approaching object. In this case, in the charge/discharge means 2 and the characteristic extraction means 3 or the charge/discharge process 62 and the characteristic extraction process 63, it is common to use means or a method of charging predetermined electric charges, for example, with constant current for a predetermined time after initialization, measuring voltage of the detection electrodes 42 is measured or a constant current charging time is measured until the voltage reaches regular voltage after initialization, on the contrary, applying regular voltage to the detection electrodes 42, discharging, and directly or indirectly measuring the amount of electric charges flowing at the discharging time. In addition, it is possible to improve positional precision by a weighted average using change in electrostatic capacitance of peripheral detection electrodes 42 or between the detection electrodes of peripheral intersections.

Next, means or a method, which is called a shunt method, using change in electrostatic capacitance between electrodes such as intersections of the plurality of 2-dimensionally arranged detection electrodes 42 of the detection panel 1 will be described. In this case, a predetermined voltage waveform is applied using a one-side dimensional detection electrode of the generally 2-dimensionally arranged detection electrodes 42 as a transmission electrode, and electric charges flowing in as a reception electrode in which the other-side dimensional detection electrode 42 is low impedance are measured. In addition, in the same manner as the load method, it is possible to improve positional precision by a weighted average using change in electrostatic capacitance of peripheral detection electrodes 42 or between the detection electrodes 42 of peripheral intersections.

In addition, means or a method, which is called a surface method, of applying the same alternating voltage from four corners of a rectangular electrode over the whole detection face, measuring electric current values, calculating approach position of the object from a balance of change of the electric current value may be used.

The invention can realize the electrostatic detection device and the electrostatic detection method of removing the influence of noise using various methods as described above.

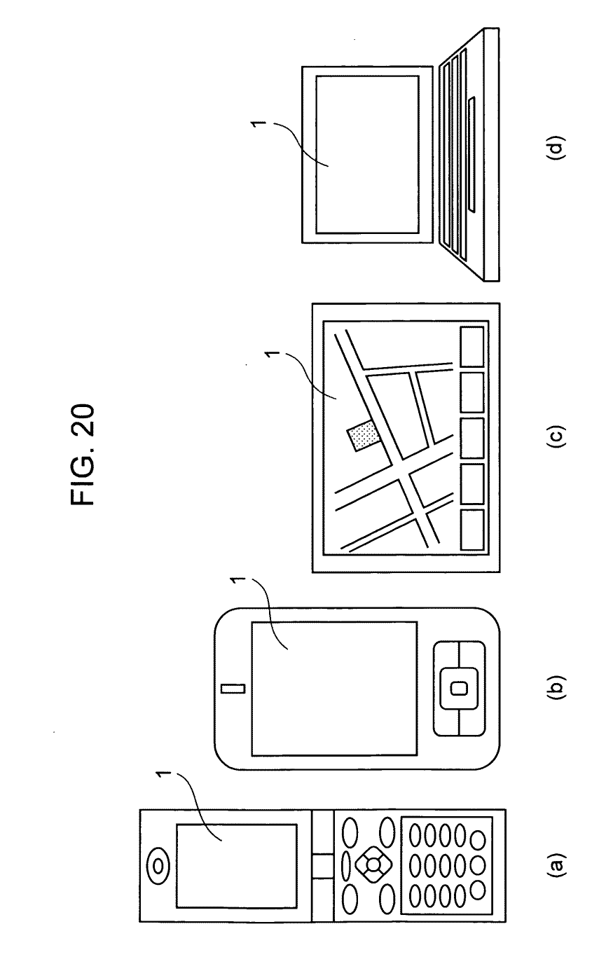

According to the electrostatic detection device and the electrostatic detection method of the invention, a transparent detection panel is overlapped on a display device such as a mobile phone as shown in FIG. 20(a), a multimedia player as shown in FIG. 20(b), a navigation system as shown in FIG. 20(c), and a computer as shown in FIG. 20(d), and thus it is possible to configure an information apparatus, such as a mobile apparatus and a computer, which has a strong noise attenuation characteristic and is capable of a stable operation.

A configuration of the information apparatus shown in FIGS. 20(a) to (d) includes a case that protects the information apparatus, a display that outputs information, the electrostatic detection device of the invention that receives an input from the detection panel 1 and specifies approach or a position of an object, and a CPU that controls an input from the electrostatic detection device and an output to the display. As shown in FIG. 20(a), FIG. 20(b), or FIG. 20(d), a keyboard may be installed in the information apparatus.

### REFERENCE SIGNS LIST

1: DETECTION PANEL

2: CHARGE/DISCHARGE MEANS

3: CHARACTERISTIC EXTRACTION MEANS

4: ACCUMULATION ANALOG/DIGITAL CONVERSION MEANS

5: POST-PROCESSING MEANS

7: CONTROL MEANS

8: ACCUMULATION MEANS

9: ANALOG/DIGITAL CONVERSION MEANS

10: ABNORMALITY DETECTION MEANS

21: INTEGRATION MEANS

22: MAINTENANCE MEANS

23: DISTURBANCE EXTRACTION MEANS

24: FILTER MEANS

25: SUBTRACTION MEANS

26: ABSOLUTE VALUE CALCULATION MEANS

27: COMPARISON MEANS

31: THRESHOLD VALUE GENERATION MEANS

33: MULTIPLIER

41: SUPPORT SUBSTRATE

42a, 43b: DETECTION ELECTRODE

51: QV CONVERSION MEANS

52: GAIN CHANGING MEANS

53: INVERSION MEANS

54: VARIABLE GAIN QV CONVERSION MEANS

55: VARIABLE GAIN INVERSION MEANS

62: CHARGE/DISCHARGE PROCESS

63: CHARACTERISTIC EXTRACTION PROCESS

64: ACCUMULATION ANALOG/DIGITAL CONVERSION PROCESS

65: POST-PROCESSING PROCESS

68: ACCUMULATION PROCESS

69: ANALOG/DIGITAL CONVERSION PROCESS

71: QV CONVERSION PROCESS

72: GAIN CHANGING PROCESS

73: INVERSION PROCESS

91: ABNORMALITY DETECTION PROCESS

92: INTEGRATION PROCESS

93: MAINTENANCE PROCESS

94: DISTURBANCE EXTRACTION PROCESS

95: SUBTRACTION PROCESS

96: ABSOLUTE VALUE CALCULATION PROCESS

97: COMPARISON PROCESS

11: DETECTION PANEL OF EXAMPLE OF PRIOR ART

12: CHARGE/DISCHARGE MEANS OF EXAMPLE OF PRIOR ART

13: CHARACTERISTIC EXTRACTION MEANS OF EXAMPLE OF PRIOR ART

14: ACCUMULATION MEANS OF EXAMPLE OF PRIOR ART

16: ANALOG/DIGITAL CONVERSION MEANS OF EXAMPLE OF PRIOR ART

15: POST-PROCESSING MEANS OF EXAMPLE OF PRIOR ART

17: CONTROL MEANS OF EXAMPLE OF PRIOR ART

1. An electrostatic detection device detecting approach or a position of an object such as a human finger by changes in electrostatic coupling, comprising:
a detection panel including one or a plurality of detection electrodes;
charge/discharge means for repeatedly performing charge/discharge of the detection electrodes of the detection panel;
characteristic extraction means for repeatedly extracting characteristics of the charge/discharge which are changed by approach of the object;
accumulation analog/digital conversion means for accumulating the characteristics repeatedly extracted by the characteristic extraction means and performing analog/digital conversion;
post-processing means for calculating approach or a position of the object from an output of the accumulation digital/analog conversion means; and
control means for managing an overall state and sequence,
wherein the characteristic extraction means includes QV conversion means for converting charge/discharge characteristics into values, inversion means for performing inversion synchronizing with the charge/discharge, and gain changing means for changing a gain of first and last characteristic extraction of the repeated charge/discharge.

2. The electrostatic detection device according to claim 1, wherein in the gain changing means, when a time from an anterior edge to a posterior edge of the charge/discharge is f and a time from the posterior edge to an anterior edge of the next charge/discharge is r, a first gain in the charge/discharge which is repeated at the same timing is different from other gains.

3. The electrostatic detection device according to claim 1, wherein in the gain changing means, when a time from an anterior edge to a posterior edge of the charge/discharge is f and a time from the posterior edge to an anterior edge of the next charge/discharge is r, a last gain in the charge/discharge which is repeated at the same timing is different from other gains.

4. The electrostatic detection device according to claim 1, wherein in the gain changing means, when a time from an anterior edge to a posterior edge of the charge/discharge is f and a time from the posterior edge to an anterior edge of the next charge/discharge is r, a first gain or a last gain in the charge/discharge which is repeated at the same timing is in the range of 0.2 times or more and 0.8 times or less of other gains.

5. The electrostatic detection device according to claim 1, wherein in the gain changing means, the gain is determined by a difference of a resistance value.

6. The electrostatic detection device according to claim 1, wherein in the gain changing means, the gain is determined by a difference of an on-time of a switch.

7. An electrostatic detection device detecting approach or a position of an object such as a human finger by a change in electrostatic coupling, comprising:
an electrode panel including one or a plurality of detection electrodes;
charge/discharge means for repeatedly performing charge/discharge of the detection electrodes of the detection panel;
characteristic extraction means for repeatedly extracting characteristics of the charge/discharge changed by approach of the object;
accumulation analog/digital conversion means for accumulating the characteristics repeatedly extracted by the characteristic extraction means and performing analog/digital conversion;
post-processing means for calculating approach or a position of the object from an output of the accumulation digital/analog conversion means;
abnormality detection means for detecting whether or not there is an abnormality in an output of the characteristic extraction means; and
control means for managing an overall state and sequence.

8. The electrostatic detection device according to claim 7, wherein the abnormality detection means including
maintenance means for maintaining characteristics of charge/discharge before the outputting by the characteristic extraction means,
disturbance extraction means for extracting an extent of influence of noise included in the characteristics of the charge/discharge from the characteristics of the charge/discharge and an output of the maintenance means, and
comparison means for comparing an output of the disturbance extraction means with a threshold value.

9. The electrostatic detection device according to claim 7, wherein the abnormality detection means includes integration means for integrating the charge/discharge characteristics corresponding to the plurality of detection electrodes output by the characteristic extraction means.

10. The electrostatic detection device according to claim 7, wherein when the abnormality detection means detects an abnormality, a digital value from the accumulation analog/digital conversion means is corrected by the processing means according to the number of abnormality times.

11. The electrostatic detection device according to claim 7, wherein when the abnormality detection means detects an abnormality, the charge/discharge by the charge/discharge means and the characteristic extraction by the characteristic extraction means are repeated by as much as one charge/discharge.

12. The electrostatic detection device according to claim 8, wherein the disturbance extraction means includes subtraction means for calculating a difference between the characteristics of the charge/discharge and those of the maintenance means, and absolute value extraction means for extracting an absolute value of an output of the subtraction means.

13. The electrostatic detection device according to claim 8, wherein the abnormality detection means includes threshold value generation means for inputting an amount of change output by the disturbance extraction means and outputting a threshold value to the comparison means.

14. The electrostatic detection device according to claim 8, wherein the abnormality detection means includes threshold value generation means for inputting a deviation output by the disturbance extraction means and outputting a threshold value to the comparison means.

15. The electrostatic detection device according to claim 8, wherein the threshold value of the comparison means includes an upper limit threshold value and a lower limit threshold value, and the abnormality detection means determines an abnormality when characteristics of charge/discharge are out of the range of the upper limit threshold value and the lower limit threshold value.

16. An electrostatic detection method of detecting approach or a position of an object such as a human finger by changes in electrostatic coupling, comprising:
a charge/discharge process of repeatedly performing charge/discharge of detection electrodes of a detection panel;
a characteristic extraction process of repeatedly extracting characteristics of the charge/discharge changed by approach of the object;
an accumulation analog/digital conversion process of accumulating the characteristics repeatedly extracted by the characteristic extraction means and performing analog/digital conversion;
a post-processing process of calculating approach or a position of the object from an output of the accumulation digital/analog conversion means; and
a control process of managing an overall state and sequence,
wherein the characteristic extraction process includes a QV conversion process of converting charge/discharge characteristics into values, an inversion process of performing inversion synchronizing with the charge/discharge, and a gain changing process of changing a gain of first and last characteristic extraction.

17. The electrostatic detection method according to claim 16, wherein in the gain changing process, when a time from an anterior edge to a posterior edge of the charge/discharge is f and a time from the posterior edge to an anterior edge of the next charge/discharge is r, a first gain in the charge/discharge which is repeated at the same timing is different from other gains.

18. The electrostatic detection method according to claim 16, wherein in the gain changing process, when a time from an anterior edge to a posterior edge of the charge/discharge is f and a time from the posterior edge to an anterior edge of the next charge/discharge is r, a last gain in the charge/discharge which is repeated at the same timing is different from other gains.

19. The electrostatic detection method according to claim 16, wherein in the gain changing process, when a time from an anterior edge to a posterior edge of the charge/discharge is f and a time from the posterior edge to an anterior edge of the next charge/discharge is r, a first gain or a last gain in the charge/discharge which is repeated at the same timing is in the range of 0.2 times or more and 0.8 times or less of other gains.

20. The electrostatic detection method according to claim 16, wherein in the gain changing process, the gain is determined by a difference of a resistance value.

21. The electrostatic detection method according to claim 16, wherein in the gain changing process, the gain is determined by a difference of an on-time of a switch.

22. An electrostatic detection method of detecting approach or a position of an object such as a human finger by changes in electrostatic coupling, comprising:
a charge/discharge process of repeatedly performing charge/discharge of detection electrodes of a detection panel;
a characteristic extraction process of repeatedly extracting characteristics of the charge/discharge changed by approach of the object;
an accumulation analog/digital conversion process of accumulating the characteristics repeatedly extracted by the characteristic extraction process and performing analog/digital conversion;
a post-processing process of calculating approach or a position of the object from an output of the accumulation digital/analog conversion process; and
an abnormality detection process of detecting whether or not there is abnormality in an output of the characteristic extraction means; and
a control process of managing an overall state and sequence.

23. The electrostatic detection method according to claim 22, wherein the abnormality detection process including
maintenance means for maintaining characteristics of charge/discharge before the outputting of the characteristic extraction process,
a disturbance extraction process of extracting an extent of influence of noise included in the characteristics of the charge/discharge from the characteristics of the charge/discharge and an output of the maintenance process, and
a comparison process of comparing an output of the disturbance extraction process with a threshold value.

24. The electrostatic detection method according to claim 22, wherein the abnormality detection process includes an integration process of integrating the charge/discharge characteristics corresponding to the plurality of detection electrodes output by the characteristic extraction process.

25. The electrostatic detection method according to claim 22, wherein when the abnormality detection process detects an abnormality, a digital value from the accumulation analog/digital conversion process is corrected according to the number of abnormality times by the processing process.

26. The electrostatic detection method according to claim 22, wherein when the abnormality detection process detects an abnormality, the charge/discharge by the charge/discharge process and the characteristic extraction by the characteristic extraction process are repeated as much as one charge/discharge.

27. The electrostatic detection method according to claim 23, wherein the disturbance extraction process includes a subtraction process of calculating a difference between the characteristics of the charge/discharge and those of the maintenance process, and an absolute value extraction process of extracting an absolute value of an output of the subtraction process.

28. The electrostatic detection method according to claim 23, wherein the abnormality detection process includes a threshold value generation process of inputting an amount of change output by the disturbance extraction process and outputting a threshold value to the comparison process.

29. The electrostatic detection method according to claim 23, wherein the abnormality detection process includes a threshold value generation process of inputting a deviation output by the disturbance extraction process and outputting a threshold value to the comparison process.

30. The electrostatic detection method according to claim 23, wherein the threshold value of the comparison process includes an upper limit threshold value and a lower limit threshold value, and the abnormality detection process determines there is an abnormality when characteristics of charge/discharge are out of the range of the upper limit threshold value and the lower limit threshold value.

31.-35. (canceled)
